(19) United States
(12) Patent Application Publication
(10) Pub. No.: US 2024/0078078 A1
(43) Pub. Date: Mar. 7, 2024

(54) AUGMENTED AUDIO OVERLAY

(71) Applicant: SignGlasses, LLC, Provo, UT (US)

(72) Inventors: Korey Hocker, Orem, UT (US); Matthew Steiner, Salt Lake City, UT (US); Spencer Steiner, Holladay, UT (US)

(21) Appl. No.: 17/939,735

(22) Filed: Sep. 7, 2022

(51) Int. Cl. G06T 19/00; G02B 27/01; G06F 3/16

(52) U.S. Cl. CPC G06T 19/006; G02B 27/017; G06F 3/165

(57) ABSTRACT

A system for providing augmented audio layering services receives from a microphone a first audio recording of ambient noise. The system then accesses a database of audio fingerprints. Each fingerprint within the audio fingerprints comprises information for identifying time stamps within audio files associated with each audio fingerprint. The system identifies within the first audio recording a particular audio fingerprint from the database of audio fingerprints. Additionally, the system identifies within the particular audio fingerprint a particular timestamp associated with the first audio recording. The system then accesses a database of translated audio. Further, the system accesses, within the augmented audio files, a portion of a particular augmented audio file that corresponds with the particular timestamp. The system then communicates the portion of the particular augmented audio file to a speaker device for playing

### BACKGROUND

Hearing loss affects many people around the world. To assist individuals with impaired hearing, various devices, such as hearing aids, have become available. While hearing aids provide an important service to some individuals with impaired hearing, hearing aids often are unable to assist individuals with disabling levels of hearing loss.

Historically, many individuals with disabling hearing loss have relied upon sign language to communicate. Persons with impaired hearing are often provided with translation services in a variety of circumstances. For example, educational institutions such as colleges and universities are required under Title III of the Americans with Disabilities Act (ADA) to provide deaf and hard of hearing students with qualified interpreters, captioning, assistive listening devices, and/or other auxiliary aids and services. AMERICANS WITH DISABILITIES ACT OF 1990, PL 101-336, Jul. 26, 1990. These requirements apply to postsecondary educational institutions whether or not they receive any form of federal financial assistance.

Beyond the educational sphere, hosts of presentation or lecture events often desire to provide cost-efficient interpretation services for attendees with impaired hearing. For lengthy events, multiple translators are often necessary. Additionally, individuals with impaired hearing may desire on-demand translation services for events that would require multiple and/or specialized interpreters. Similar challenges are experienced by museums, cultural attractions, amusement parks, airports, and nearly any other public facing accommodation that desires to communicate publicly to its patrons.

Therefore, there exists a need for improved systems and methods for facilitating on-demand interpretation services.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein comprise methods, systems, and apparatus for providing augmented audio layering services. For example, disclosed embodiments comprise systems that receive from a microphone a first audio recording of ambient noise. The system then accesses a database of audio fingerprints. Each fingerprint within the audio fingerprints comprises information for identifying time stamps within audio files associated with each audio fingerprint. The system identifies within the first audio recording a particular audio fingerprint from the database of audio fingerprints. Additionally, the system identifies within the particular audio fingerprint a particular timestamp associated with the first audio recording. The system then accesses a database of translated audio. Further, the system accesses, within the augmented audio files, a portion of a particular augmented audio file that corresponds with the particular timestamp. The system then communicates the portion of the particular augmented audio file to a speaker device for playing

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings, as summarized below.

FIG. 1 illustrates an embodiment of a system for providing augmented audio overlay.

FIG. 2 illustrates an embodiment of a system for providing augmented audio overlay with respect to a play or movie.

FIGS. 3A-3D illustrate an embodiment of noise cancellation.

FIGS. 4A-4B illustrate an embodiment of noise amplification.

FIG. 5 illustrates a flow chart of a method for providing augmented audio overlay.

### DETAILED DESCRIPTION

Embodiments disclosed herein comprise methods, systems, and apparatus for providing augmented audio overlay services. For example, disclosed embodiments comprise an audio device and a recording device working together in tandem. The recording device capture audio noise from the user's environment. The noise is mapped to audio fingerprints within a database of pre-recorded, pre-fingerprinted audio files. Once an appropriate audio file is identified by fingerprint, a timestamp associated within the currently recorded audio is identified. The timestamp is used to identify a correct location within an augmented audio file. The augmented audio is then played to the user such that the augmented audio is overlaid on the real-time audio to which the user is listening.

As used herein, “augmented audio” comprises audio information of specific audio content and/or recordings of audio content with select portions of the audio removed or diminished, select portions of the audio shifted in frequency, and/or select portions of the audio amplified. For example, an augmented audio file of a movie may comprise only the spoken portions of the movie without any background noises or special effect noises. Additionally, in this exemplary augmented audio file, the spoken portions may be amplified such that they are louder than normal. Further, in some embodiments, the real-time spoken portions may be frequency shifted up or down. Further still, the augmented audio may comprise information that can be used to cancel audio content and amplify audio content in real-time. For example, the audio information may comprise information that can be used to cancel specific portions of audio from a real-time audio stream or to amplify portions of a real-time audio stream.

Accordingly, in some embodiments, an individual who is hard of hearing may be better able to enjoy watching the movie with the augmented audio file because the individual will hear the amplified spoken portions of the dialogue without background noises that can make the dialogue harder to hear. Additionally, in some embodiments, the dialogue may be frequency shifted to a frequency range that the individual is better able to hear.

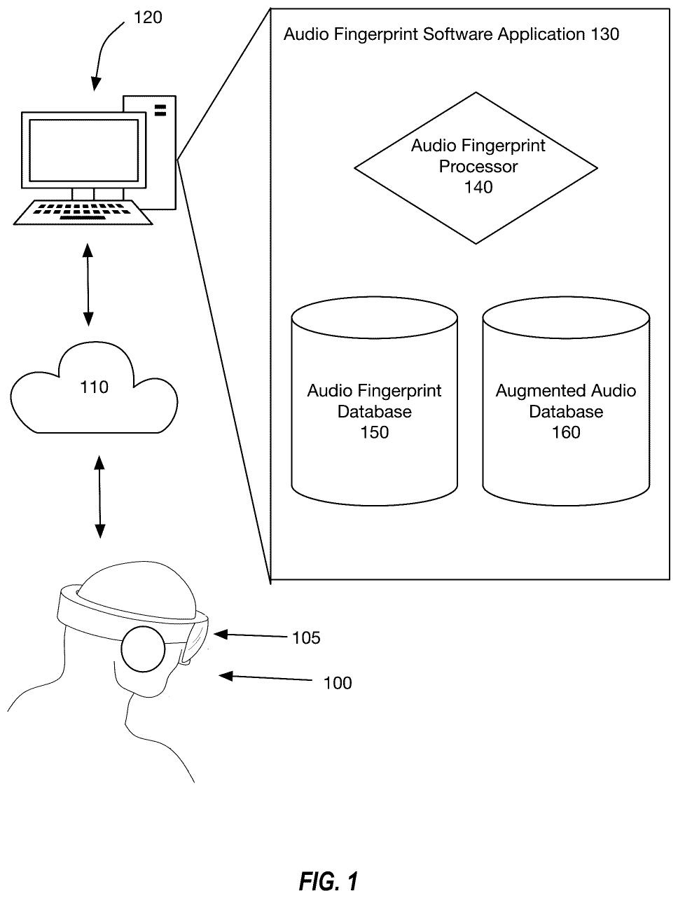

Turning now to the figures, FIG. 1 illustrates an embodiment of a computer system 120 for providing augmented audio overlay services. In the depicted embodiment, a head-mounted device 105 is in communication with a computer system 120 through a network connection 110. In the depicted embodiment, the head mounted device 105 includes headphones and a display, however, in additional or alternative embodiments, the head mounted device 105 may only comprise a speaker device, such as headphones. As used herein, speaker devices include over the ear headphones, earbuds, hearing aids, or any other device capable of playing sound to an individual user. Additionally, one will appreciate that the depicted embodiment is merely exemplary. In additional or alternative embodiments, the computer system 120 may be wholly integrated or partially (e.g., a distributed system) integrated within the head-mounted device 105. As such, in at least one embodiment, it is not necessary for the head-mounted device 105 to communicate through a network connection 110; instead, all of the necessary databases and processing capabilities may be present within the head-mounted device 105 itself.

In at least one embodiment, the head-mounted device 105 is configured to communicate to the computer system 120 through a network connection, such as a WIFI connection. The computer system 120 may be located within the same building as the head-mounted device 105 or may be a remote server that is connected to the Internet. The head-mounted device 105 may be configured to gather ambient noise through a microphone and/or visual images from a camera and transmit the recorded data to the computer system 120.

The computer system 120 comprises an audio fingerprint software application 130 that is configured to process the received audio data. For example, the audio fingerprint software application 130 may comprise an audio fingerprint processor 140 that matches the received ambient noise recording to an audio fingerprint stored within the audio fingerprint database 150. The audio fingerprint processor 140 may comprise a software algorithm, a hardware processor, and/or a combination thereof.

The audio fingerprint processor 140 identifies within the audio recording a particular audio fingerprint by converting the recorded audio into spectrograms, Fourier transforms, or any other known means for fingerprinting an audio signal. As mentioned above, one will appreciate that this step and other steps may be performed locally at a portion of the computer system 120 located in the head-mounted device 105 or at a remote computer system 120. The audio fingerprint processor 140 may then access the audio fingerprint database 150. Each fingerprint within the audio fingerprint database 150 comprises information for identifying time stamps within audio files associated with each audio fingerprint.

The audio fingerprint processor 140 identifies within the particular audio fingerprint a particular timestamp associated with the first audio recording. The audio fingerprint processor 140 then accesses an augmented audio database 160 and accesses a portion of the augmented audio that corresponds with the particular time stamp. The computer system 120 sends the portion of the augmented audio to the head-mounted device 105 where the augmented audio is played to the user.

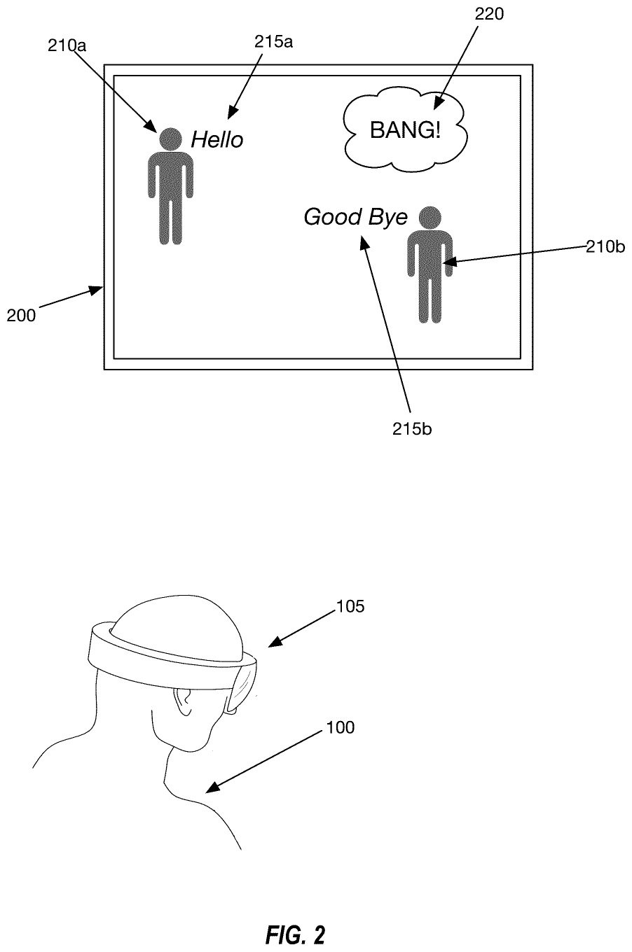

FIG. 2 illustrates an embodiment of a system for providing augmented audio overlay services with respect to a movie. The depicted embodiment comprises a user 100 wearing a head-mounted device 105. The user is viewing a play 200 that is displaying a first individual 210a conversing with a second individual 210b. One will appreciate that the depicted figure is provided only for the sake of example and explanation. In various additional or alternative embodiments, the user 100 may be wearing a different configuration of a head-mounted device 105. Additionally, in at least one embodiment, the head-mounted device 105 may only comprise headphones while any necessary processing is performed by a mobile computing device, such as a smart phone, tablet, laptop, or wearable. Accordingly, one will appreciate that any reference to a specific hardware configuration within this specification is merely exemplary unless otherwise stated is not limiting the invention to a particular device or system.

Additionally, in at least one embodiment, the user 100 may be viewing a scene other than a play 200. For example, the user may be viewing a television screen, a computer screen, a music performance, or any other audio performance.

In at least one embodiment, the head-mounted device 105 comprises a microphone that receives an audio recording of ambient noise. As in FIG. 2, when the user is watching a play, the ambient noise comprises the dialogue, music, and special effects of the play 200. One will appreciate that in some circumstances the ambient noise also comprises environmental noise such as other people in the audience conversing, the sound of air conditioning, the sounds of people moving in their seats, etc. As such, the system is capable of filtering out environment noise and/or identifying the target audio (i.e., the audio track of the movie) despite the environmental noise. In the depicted example, the audio track comprises the first individual 210a saying “Hello” to the second individual and the second individual 210b saying “Good Bye” to the first individual 210a. Additionally, the audio track comprises an explosion in the background, which is represented by the “BANG!” bubble 220.

Once the head-mounted device 105 has captured the audio recording, the system accesses an audio fingerprint database 150. The database of audio fingerprints may comprise spectrograms, Fourier transforms, or any other known means for fingerprinting an audio signal. Additionally, each fingerprint within the audio fingerprints comprises information for identifying time stamps within audio files associated with each audio fingerprint.

Additionally or alternatively, the system may comprise an interface that allows a user to enter information relating to the movie, TV show, play, or other performance event. For example, a user may select the play title or enter the play name into the interface. The system may then search for the audio track based upon the user input. Once the audio track is found, the system may utilize an audio fingerprint of the currently received ambient noise to identify a time stamp within the audio track that matches the ambient noise that the head-mounted device 105 is currently receiving.

As such, the audio fingerprint identities the audio that is being recorded and identifies a time stamp, or position in time, where the audio is relative to the total recorded length of the audio file. For example, the user 100 may be watching a 90-minute play 200. The audio fingerprint that is derived from the recorded audio can determine that the first individual 210a says “Hello” and the second individual 210b says “Good Bye” at exactly 37 minutes 15 seconds into the play 200. In at least one embodiment, the database of audio fingerprints comprises a network connected database of movies, TV shows, museum guided-tours, songs, and any other audio file that has been uploaded and analyzed into the database.

Once the timestamp of the recorded audio has been identified, the system accesses an augmented audio database 160. The augmented audio database 160 may comprise augmented audio files for various movies, plays, presentations, etc. In some embodiments, a provider of the computer system 120 may pre-load specific augmented audio files of interest into the augmented audio database 160. For instance, a Shakespeare festival may preload augmented audio for all of the planned plays into the augmented audio database 160. The system can access a portion of the augmented audio that corresponds with the particular time stamp that was received from the database of audio fingerprints.

In at least one embodiment, the computer system 120 plays, at the speaker device, the portion of the particular augmented audio file such that the portion of the particular augmented audio file is synchronized with the ambient noise. In one example, the particular augmented audio file comprises a recording of one or more individuals reciting a particular dialogue, and the ambient noise comprises a real-time recitation of the particular dialogue. In at least one embodiment, the recording of the one or more individuals reciting the particular dialogue is in a different language than the real-time recitation of the particular dialogue. For example, in at least one embodiment, a user can utilize the system to play augmented audio in a different language than the real-time dialogue. Accordingly, the augmented audio overlay can provide language translation services to users who need language translation services.

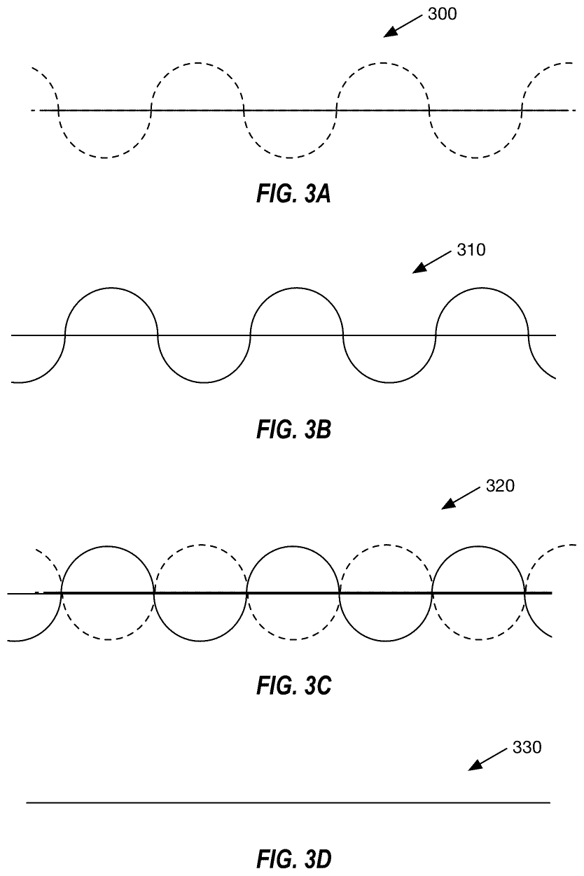

The augmented audio may comprise various features to assist a user with hearing particular aspects of the audio. For example, FIGS. 3A-3D illustrate an embodiment of noise cancellation features within augmented audio. For instance, the play 200 may comprise several explosions 220 or gun shots that occur during dialogue in the play. Due to the explosions and gun shots, it may be difficult for a user who is hard of hearing to hear the dialogue. Accordingly, in at least one embodiment, the augmented audio may comprise noise cancellation that is mapped to the explosions 220 and gun shots but not to the dialogue.

For example, FIG. 3A depicts an audio waveform 300. In this example the audio waveform 300 comprise the explosion 220. One will appreciate that the depicted waveform has been significantly simplified. In practice the waveform 300 may comprise significantly greater complexity and may comprise multiple sounds in addition to the explosion 220. FIG. 3B depicts an inverted waveform 310, or cancelling waveform. The inverted waveform 310 is the inversion of waveform 300. In FIG. 3C, the waveform 300 is added to the inverted waveform 310 to create an additive waveform 320. As one of skill in the art would appreciate, and as depicted in FIG. 3D, the waveform 300 and the inverted waveform 310 cancel each other out. Accordingly, through the use of an active noise control system the sound of the explosion 220 can be cancelled out by the head-mounted device 105. The end user, who is hard of hearing, is then able to enjoy the dialogue without the added noise of the explosion.

In at least one embodiment, the waveform 300 is based upon a prerecorded sound. For instance, the explosion 220 may comprise a recording that is played during every rendition of the place. In such circumstances, the augmented audio database 160 may comprise the inverted waveform 310 of the pre-recorded sound. The inverted waveform 310 may be used to increase the accuracy and speed of the noise cancellation performed by the head-mounted device 105. For example, due to the unique location of the user 100 with respect to the stage, the user's head-mounted device 105 may need to perform local processing in order to properly cancel the sound waves as heard by the user 100. The head-mounted device 105 may be able to utilize information from the pre-recorded explosion to reduce processing load and increase the efficiency of the noise cancellation.

In at least one embodiment, the head-mounted device 105 utilizes the prerecorded sound wave 300 in order to properly cancel out the desired audio while allowing other audio to continue unimpeded. For instance, in the case that the explosion occurs during dialogue, the head-mounted device 105 may utilize the augmented audio (i.e., audio information about the explosion) to identify and cancel out the explosion while avoiding unintentionally cancelling out the dialogue.

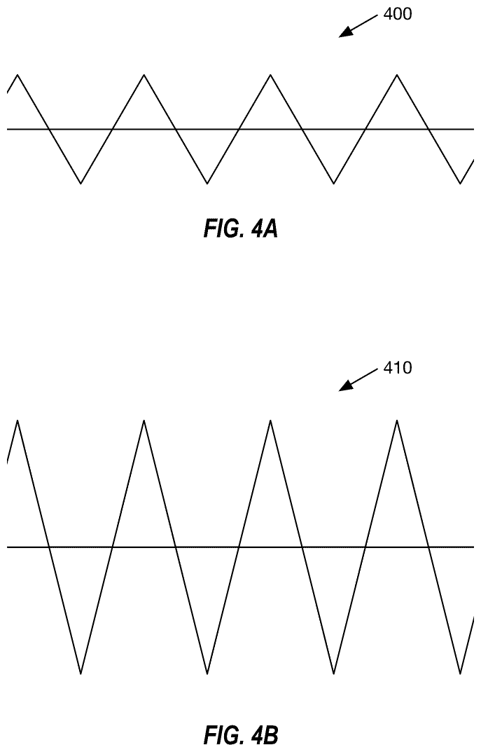

In addition to including information for cancelling out undesired audio, the augmented audio files may also comprise information for amplifying particular audio. FIG. 4A depicts a simplified audio waveform 400 of target audio that the user 100 desires to hear better. FIG. 4B depicts an embodiment of augmented in the form of a simplified audio waveform 410 of the target audio that has been amplified for the user 100 to hear.

For example, the simplified audio waveform 400 may comprise dialogue that is spoken during the play 200. The dialogue within the play may comprise pre-recorded dialogue or dialogue that is spoken live. In the case that the dialogue is spoken live, the augmented audio file may comprise a recording of the actor previously speaking the dialogue and/or average audio file the actor speaking the dialogue over time. In some embodiments where multiple actors are used in the same part, each actor may be associated with a unique augmented audio file.

In at least one embodiment, the head-mounted device 105 is configured to play the amplified augmented audio in sync with the actor speaking such that the user is able to more loudly hear the dialogue in real-time. The step of syncing the audio may comprise similar steps to what is used in noise cancellation, but instead of injecting an inverse of the audio waveform, instead the additive to the audio waveform is injected by the head-mounted device 105. Additionally or alternatively, instead of playing a digital recording of the amplified augmented audio, the head-mounted device 105 may utilize the audio fingerprint of the actor speaking to identify the target audio. In response to identifying the target audio, the head-mounted device 105 may increase the volume on the real-time audio such that the augmented audio is being created in real-time. Accordingly, one will appreciate that in some embodiments, the augmented audio database 160 may not be necessary because both noise cancellation and noise amplification can generated in real-time using information within the audio fingerprint database 150.

In at least one embodiment, throughout the augmented audio layering process, a microphone integrated into the head-mounted device 105 continues to receive an audio recording of the ambient noise. The head-mounted device 105 continues to identify within the particular audio fingerprint a second timestamp associated with the second audio recording. The head-mounted device 105 resynchronizes the portion of the augmented audio with the second timestamp. As such, the head-mounted device 105 is continually resynchronizing the augmented audio to the recorded audio. Such resynchronization may assist in the accuracy and fidelity of the augmented audio and/or the ability to identify when a new audio track is being played.

Additionally, in at least one embodiment, a user may have the ability to adjust one or more variables to selectively determine the characteristics of the augmented audio. For example, the audio fingerprint software application 130 may provide a user with the ability select the sounds that the user would like to have amplified and the sound that the user would like to have cancelled. For instance, the head-mounted device 105 may be a set of headphones and an associated smart phone that is running an application that comprises a part of, or is in communication with, the audio fingerprint software application 130. The smart phone application may provide the user 100 with the options of amplifying spoken words, amplifying spoken words within particular frequency ranges (e.g., relatively higher frequency voices such as female voices), amplifying specific background noises, cancelling or minimizing background noises, cancelling or minimized background noises that overlap with dialogue, cancelling or minimizing noises over a specific decibel level, and/or otherwise selecting particular audio portions for amplification or cancellation.

In at least one embodiment, the augmented audio database 160 may comprise a variety of different augmented audio files for a given item, such as a given movie, given play, or other audio event. Further, a particular augmented audio file may comprise one or more non-dialogue background noises. For example, the particular augmented audio file may comprise audio of background noises that are important to understanding the play. In such a situation, the particular augmented audio file may amplify the background noises to enable the user to better hear the audio.

In some embodiments, a particular play, movie, TV show, performance, or other audio content may come associated with suggested defaults for what content should be amplified and what content should be cancelled for a user who is hard of hearing. The user may be provided further options to adjust the default settings to meet their own particular interests. Additionally, in some embodiments, the user may be provided with options to activate visual translation, such as a sign language translation or a closed captions translation of the audio content. The visual translation may appear on a head-mounted display, on the user's smart phone, or on any other device with a compatible user interface.

In view of the disclosed embodiments, one will appreciate the benefit provided by the systems and methods for providing on-demand augmented audio overlay. For example, a user 100 can bring a head-mounted device 105 to any location with audio that has been catalogued in the audio fingerprint database 150 and/or the augmented audio database 160. If the audio has been fingerprinted and augmented audio identified, the user 100 is provided with on-demand augmented audio overlay services that do not require any external systems. Additionally, the disclosed systems provide significant customizability to an end-user that can parse real-time audio to amplify particular portions of the audio and cancel or diminish other portions of the audio.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

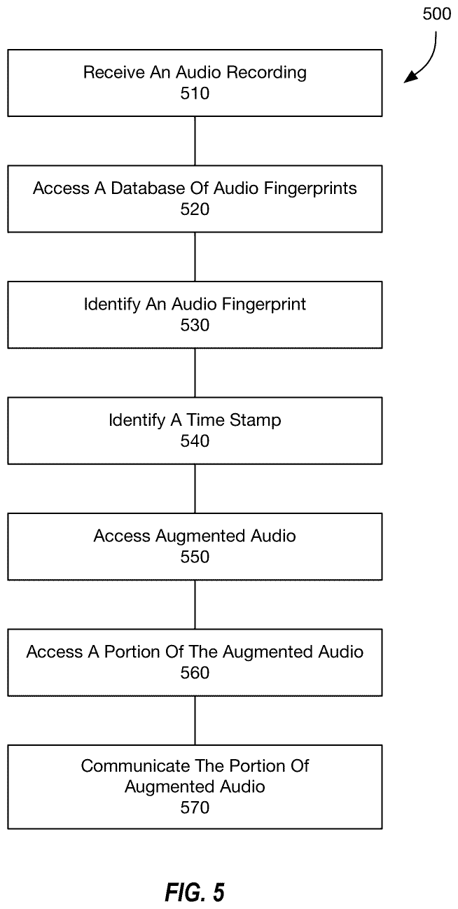

FIG. 5 illustrates various steps in a flowchart for a method 500 of providing on-demand audio overlay services. The method 500 includes an act 510 of receiving an audio recording. Act 410 can comprise receiving from a microphone a first audio recording of ambient noise. For example, the head-mounted device 105 of FIG. 2 may comprise a microphone that receives a recording of audio from the play 200.

Method 500 also includes an act 520 of accessing a database of audio fingerprints. Act 520 can comprise accessing an audio fingerprint database 150, wherein each fingerprint within the audio fingerprints comprises information for identifying time stamps within audio files associated with each audio fingerprint. For example, the head-mounted device 105 can connect to an audio fingerprint database 150 through a network connection 110 or may connect to a locally stored audio fingerprint database 150. As used herein, the audio fingerprint database 150 comprises any form of stored audio fingerprints.

Additionally, Method 500 includes an act 530 of identifying an audio fingerprint. Act 530 can comprise identifying within the first audio recording a particular audio fingerprint from the audio fingerprint database 150. For example, the head-mounted device 105 can upload the audio recording directly to a network-connected audio fingerprint database 150 for analysis. In contrast, in at least one embodiment, the head-mounted device 105 can performed some initial processing prior to uploading the audio recording. For instance, the head-mounted device 105 may perform a fast-Fourier transform on the audio recording prior to uploading it to the audio fingerprint database 150.

Method 500 also includes an act 540 of identifying a time stamp. Act 540 can comprise identifying within the particular audio fingerprint a particular timestamp associated with the first audio recording. For example, the head-mounted device 105 or a remote system in communication with the head-mounted device 105 can match the audio fingerprint to a particular time stamp associated with an audio file within the database of audio fingerprints 340.

Method 500 further includes an act 550 of accessing augmented audio. Act 550 can comprise accessing an augmented audio database 160. For example, once an audio fingerprint is matched to audio file, the head-mounted device 105 or some other remote system can access an augmented audio database 1600. The augmented audio database 160 comprises augmented audio from various audio files. In at least one embodiment, wherein the translations comprise closed captions and/or videos of sign-language translations of the respective audio file.

Further, method 500 includes an act 560 of accessing augmented audio. Act 560 can comprise accessing a portion of the translated audio that corresponds with the particular time stamp. For example, the head-mounted device 105 or a remote system that is in communication with the head-mounted device 105 identifies within the augmented audio database 160 a portion of the translated audio that matches the previously identified timestamp.

Further still, method 500 includes an act 570 of communicating the portion of the augmented audio. Act 570 comprises communicating the portion of the particular augmented audio file to a speaker device for playing. For example, as depicted and described with respect to FIG. 2, the head-mounted device 105 can augment the audio heard by the user 100 by amplifying and/or cancelling particular elements of the audio from the play 200.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web based services for communicating back and forth with clients.

Many computers are intended to be used by direct user interaction with the computer. As such, computers have input hardware and software user interfaces to facilitate user interaction. For example, a modern general purpose computer may include a keyboard, mouse, touchpad, camera, etc. for allowing a user to input data into the computer. In addition, various software user interfaces may be available.

Examples of software user interfaces include graphical user interfaces, text command line-based user interface, function key or hot key user interfaces, and the like.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for providing augmented audio overlay, comprising:
receiving a first audio recording of ambient noise;
accessing a database of audio fingerprints, wherein each fingerprint within the audio fingerprints comprises information for identifying time stamps within audio files associated with each audio fingerprint;
identifying within the first audio recording a particular audio fingerprint from the database of audio fingerprints;
identifying within the particular audio fingerprint a particular timestamp associated with the first audio recording;
accessing a database of augmented audio files;
accessing, within the augmented audio files, a portion of a particular augmented audio file that corresponds with the particular timestamp, wherein the particular augmented audio file comprises both:
first audio information that is configured to in real-time cancel first audio content in the ambient noise, and
second audio information that is configured to in real-time amplify second audio content in the ambient noise; and
communicating the portion of the particular augmented audio file to a speaker device for playing.

2. (canceled)

3. (canceled)

4. The method of claim 22, wherein the recording of the one or more individuals reciting the particular dialogue is in a different language than the real-time recitation of the particular dialogue.

5. The method of claim 22, wherein the recording of the one or more individuals reciting the particular dialogue is in a different frequency range than the real-time recitation of the particular dialogue.

6. The method of claim 22, wherein the particular augmented audio file comprises one or more non-dialogue background noises.

7. The method of claim 1, further comprising:
causing the speaker device to activate an active noise control system to reduce at least a portion of the ambient noise while the speaker device plays the particular augmented audio file.

8. The method of claim 7, further comprising:
selectively reducing portions of the ambient noise based upon one or more adjustable variables.

9. The method of claim 1, wherein the speaker device comprises a mobile phone.

10. The method of claim 1, wherein the speaker device is integrated into a head-mounted display.

11. A computer system for providing augmented audio overlay, comprising:
one or more processors; and
one or more computer-readable media having stored thereon executable instructions that when executed by the one or more processors configure the computer system to:
receive a first audio recording of ambient noise;
access a database of audio fingerprints, wherein each fingerprint within the audio fingerprints comprises information for identifying time stamps within audio files associated with each audio fingerprint;
identify within the first audio recording a particular audio fingerprint from the database of audio fingerprints;
identify within the particular audio fingerprint a particular timestamp associated with the first audio recording;
access a database of augmented audio files;
access, within the augmented audio files, a portion of a particular augmented audio file that corresponds with the particular timestamp, wherein the particular augmented audio file comprises both:
first audio information that is configured to in real-time cancel first audio content in the ambient noise, and
second audio information that is configured to in real-time amplify second audio content in the ambient noise; and
communicate the portion of the particular augmented audio file to a speaker device for playing.

12. (canceled)

13. (canceled)

14. The computer system of claim 24, wherein the recording of the one or more individuals reciting the particular dialogue is in a different language than the real-time recitation of the particular dialogue.

15. The computer system of claim 24, wherein the recording of the one or more individuals reciting the particular dialogue is in a different frequency range than the real-time recitation of the particular dialogue.

16. The computer system of claim 24, wherein the particular augmented audio file comprises one or more non-dialogue background noises.

17. The computer system of claim 24, wherein the executable instructions include instructions that are executable to configure the computer system to:
cause the speaker device to activate an active noise control system to reduce at least a portion of the ambient noise while the speaker device plays the particular augmented audio file.

18. The computer system of claim 17, wherein the executable instructions include instructions that are executable to configure the computer system to:
selective reducing portions of the ambient noise based upon one or more adjustable variables.

19. The computer system of claim 11, wherein the speaker device comprises a mobile phone.

20. A computer-readable media comprising one or more physical computer-readable storage media having stored thereon computer-executable instructions that, when executed at a processor, cause a computer system to perform a method for providing augmented audio overlay, the method comprising:
receiving a first audio recording of ambient noise;
accessing a database of audio fingerprints, wherein each fingerprint within the audio fingerprints comprises information for identifying time stamps within audio files associated with each audio fingerprint;
identifying within the first audio recording a particular audio fingerprint from the database of audio fingerprints;
identifying within the particular audio fingerprint a particular timestamp associated with the first audio recording;
accessing a database of augmented audio files;
accessing, within the augmented audio files, a portion of a particular augmented audio file that corresponds with the particular timestamp, wherein the particular augmented audio file comprises both:
first audio information that is configured to in real-time cancel first audio content in the ambient noise, and
second audio information that is configured to in real-time amplify second audio content in the ambient noise; and
communicating the portion of the particular augmented audio file to a speaker device for playing.

21. The method of claim 1, further comprising:
playing, at the speaker device, the portion of the particular augmented audio file such that the portion of the particular augmented audio file is synchronized with the ambient noise.

22. The method of claim 21, wherein:
the particular augmented audio file comprises a recording of one or more individuals reciting a particular dialogue; and
the ambient noise comprises a real-time recitation of the particular dialogue.

23. The computer system of claim 11, wherein the executable instructions include instructions that are executable to configure the computer system to:
play, at the speaker device, the portion of the particular augmented audio file such that the portion of the particular augmented audio file is synchronized with the ambient noise.

24. The computer system of claim 12, wherein:
the particular augmented audio file comprises a recording of one or more individuals reciting a particular dialogue; and
the ambient noise comprises a real-time recitation of the particular dialogue.
